(19) United States
(12) Patent Application Publication
(10) Pub. No.: US 2025/0322167 A1
(43) Pub. Date: Oct. 16, 2025

(54) SYSTEMS AND METHODS TO EXTRACT SEMANTIC INFORMATION FROM DOCUMENTS

(71) Applicant: Instabase, Inc., Dover, DE (US)

(72) Inventors: Vineeth Chinmaya Murthy, Bengaluru (IN); Rafal Powalski, Warszawa (PL); Atinderpal Singh, Bathinda (IN); Slawomir Jan Biel, Warsaw (PL)

(21) Appl. No.: 18/446,662

(22) Filed: Aug. 9, 2023

(51) Int. Cl. G06F 40/30; G06F 40/166; G06F 40/284; G06F 40/40; G06N 5/01

(52) U.S. Cl. CPC G06F 40/30; G06F 40/166; G06F 40/284; G06F 40/40; G06N 5/01

(57) ABSTRACT

Systems and methods to use one or more machine learning models to summarize a set of one or more documents are disclosed. Exemplary implementations may obtain one or more documents including divisions and organized into individual hierarchies; identify the divisions using at least one of the one or more machine learning models, wherein individual sets of sections and sets of subsections are identified; create sets of semantic vectors characterizing semantic meaning of individual divisions organized at the bottom level of individual hierarchies using at least one of the one or more machine learning models, wherein semantic vectors for individual subsections are created; and recursively generate summary vectors summarizing semantic meaning of individual divisions using at least one of the one or more machine learning models, wherein summary vectors are generated for subsections based on the semantic vectors, sections based on subsection summary vectors, and documents based on section summary vectors.

### Field of the Disclosure

The present disclosure relates to using one or more machine learning models to summarize a set of one or more documents.

### BACKGROUND

Extracting information from electronic documents is known. Summarizing information from electronic documents is known. Presenting information in user interfaces is known. Large language models are known.

### SUMMARY

By virtue of the systems and methods described herein, the process of extracting information from documents (e.g., long documents) is improved by reducing the amount of information that is processed by a particular machine learning model for information extraction. Specifically, certain segments of large documents may be determined to be more likely to include useful information than others. The particular machine learning model may process only a portion or a selection of the segments in a large document. Recursively identifying such segments through a hierarchy into which individual documents are organized further reduces the amount of information processed for information extraction. Additionally, the use of segment summarizations for processing large documents (e.g., as opposed to direct use of text from the documents) reduces the amount of information that is processed by the particular machine learning model at each step of information extraction. Specifically, the particular machine learning model may process a subset of the segments of one or more documents that are determined to be most likely to include useful information.

One or more aspects of the present disclosure may relate to a system configured to use one or more machine learning models to summarize a set of one or more documents. The system may be configured to obtain one or more documents. By way of non-limiting example, the one or more documents may include a first document. The first document may include one or more sections, including a first section. By way of non-limiting example, the first section may include one or more subsections. By way of non-limiting example, the one or more subsections may include a first subsection. In some implementations, individual ones of the one or more subsections may be arranged in a particular order. By way of non-limiting example, individual ones of the one or more subsections included in the first section may be subsections within the first document. In some implementations, the first subsection may include one or more sequences of text including a first sequence of text. In some implementations, individual subsections may not include a sequence of text.

The system may be configured to identify individual sets of sections corresponding to individual ones of the one or more documents using at least one of the one or more machine learning models. By way of non-limiting example, a first set of sections from the first document may be identified. The first document may include individual sections included in the first set of sections. By way of non-limiting example, the first set of sections may include the first section. The system may be configured to identify individual sets of subsections corresponding to individual sections included in the individual sets of sections. By way of non-limiting example, a first set of subsections for the first section may be identified. The first set of subsections may include the first subsection.

The system may be configured to create individual sets of semantic vectors using at least one of the one or more machine learning models. By way of non-limiting example, a first set of semantic vectors including a first semantic vector may be created. Individual semantic vectors may characterize semantic meanings of individual subsections. By way of non-limiting example, the first semantic vector may characterize semantic meaning of the first subsection. The system may be configured to generate individual sets of subsection summary vectors in accordance with the individual sets of semantic vectors. In some implementations, the individual sets of subsection summary vectors may be generated using at least one of the one or more machine learning models. By way of non-limiting example, a first set of subsection summary vectors including a first subsection summary vector may be generated in accordance with the first set of semantic vectors. The first subsection summary vector may be generated in accordance with the first semantic vector. In some implementations, individual subsection summary vectors may summarize semantic meaning of individual subsections. By way of non-limiting example, the first subsection summary vector may summarize semantic meaning of the first subsection.

The system may be configured to generate individual sets of section summary vectors in accordance with the individual sets of subsection summary vectors. In some implementations, the individual sets of section summary vectors may be generated using at least one of the one or more machine learning models. By way of non-limiting example, a first section summary vector may be generated in accordance with the first set of subsection summary vectors. In some implementations, individual section summary vectors may summarize semantic meaning of individual sections. By way of non-limiting example, the first section summary vector may summarize semantic meaning of the first section. The system may be configured to generate individual document summary vectors in accordance with the individual sets of section summary vectors. In some implementations, the individual document summary vectors may be generated using at least one of the one or more machine learning models. By way of non-limiting example, a first document summary vector may be generated in accordance with the first set of section summary vectors. In some implementations, individual document summary vectors may summarize semantic meaning of individual documents. By way of non-limiting example, the first document summary vector may summarize semantic meaning of the first document.

As used herein, any association (or relation, or reflection, or indication, or correspondency) involving servers, processors, client computing platforms, models, documents, sections, subsections, vectors, pages, presentations, obtained information, user interfaces, and/or another entity or object that interacts with any part of the system and/or plays a part in the operation of the system, may be a one-to-one association, a one-to-many association, a many-to-one association, and/or a many-to-many association or “N”-to-“M” association (note that “N” and “M” may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “determine” (and derivatives thereof) may include measure, calculate, compute, estimate, approximate, extract, generate, and/or otherwise derive, and/or any combination thereof. As used herein, the term “generate” (and derivatives thereof) may include derive, construct, compile, create, produce, form, build, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to use one or more machine learning models to summarize a set of one or more documents, in accordance with one or more implementations.

FIG. 2A illustrates a method to use one or more machine learning models to summarize a set of one or more documents, in accordance with one or more implementations.

FIG. 2B illustrates a method to use one or more machine learning models to summarize a set of one or more documents, in accordance with one or more implementations.

FIG. 3 illustrates an exemplary page of a document, as may be used by a system configured to use one or more machine learning models to summarize documents, in accordance with one or more implementations.

FIG. 4 illustrates an exemplary document, as may be used by a system configured to use one or more machine learning models to summarize documents, in accordance with one or more implementations.

FIG. 5 illustrates an exemplary hierarchical organization of a document as may be used by a system configured to use one or more machine learning models to summarize documents, in accordance with one or more implementations.

### DETAILED DESCRIPTION

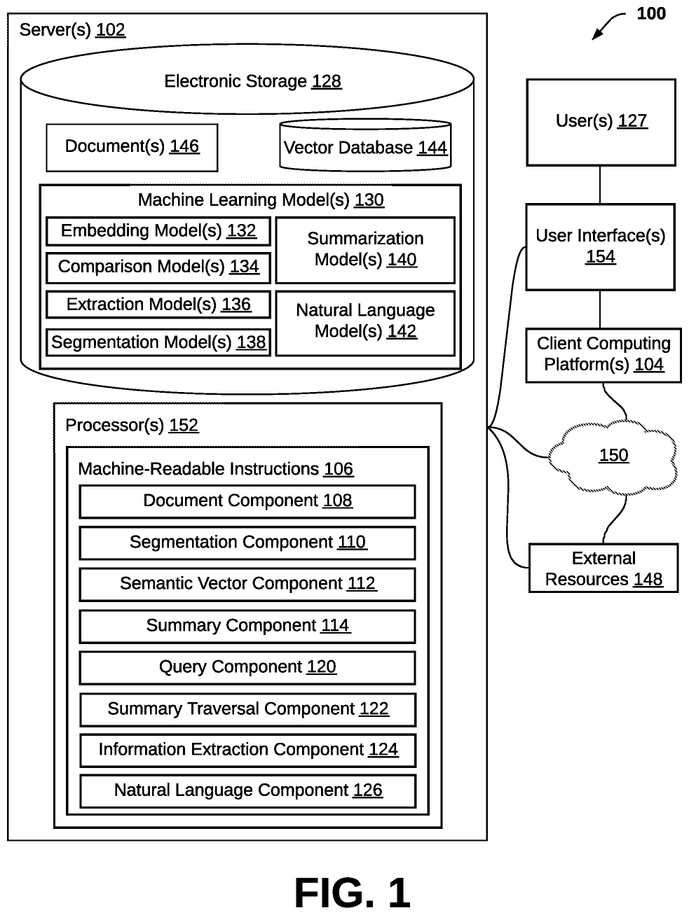

FIG. 1 illustrates a system 100 configured to use one or more machine learning models to summarize a set of one or more documents. In some implementations, individual ones of the one or more documents may be stored in one or more of a .PDF, .DOC, .XLS, .HTML, .PNG, .JPG, .TIF, and/or other file formats. Individual ones of the documents may include one or more continuous divisions. In some implementations, an individual division may be continuous such that the division is unbroken by another division within the document. As used herein, the term “division” may be used to refer to a continuous division and/or a non-continuous division. One or more divisions included in an individual document may be of one or more types of divisions. By way of non-limiting example, types of divisions may include one or more of documents, sections, subsections, divisions of a subsection, chapters, subchapters, divisions of a subchapter, paragraphs, sentences, tables, graphics, charts, topic groupings, and/or other types of divisions found in documents.

In some implementations, individual divisions included in individual documents may be organized in individual hierarchies. By way of non-limiting example, the divisions included in an individual document may be organized in an individual hierarchy. By way of non-limiting example, an individual level of an individual hierarchy may identify one or more divisions included in an individual document. In some implementations, individual divisions of one or more division types may be organized on an individual level of an individual hierarchy. By way of non-limiting example, individual sections included in an individual document may be included on an individual level of an individual hierarchy. By way of non-limiting example, a document itself and/or unsegmented contents of the document may comprise the top level of the hierarchy into which the document is organized. For example, individual subsections included in the individual document may be included on another level in the individual hierarchy. Although documents are primarily described herein as including two types of divisions (e.g., sections and subsections), this is not intended to be limiting. By way of non-limiting example, a document may have one, two, three, four, and/or any other number of types of divisions.

Individual ones of one or more documents 146 may share a common hierarchical structure and/or be organized by different individual hierarchical structures. By way of non-limiting example, individual ones of one or more documents 146 may individually be organized into a hierarchical structure with three levels. For example, the three levels may include a document level, a section level, and a subsection level. By way of non-limiting example, individual ones of one or more documents 146 may be organized into a hierarchical structure with four or more levels. For example, the four levels may include a document level, a chapter level, a subchapter level, and a paragraph level. Individual ones of one or more documents 146 may be organized into a hierarchical structure with any number of levels.

In some implementations, a continuous division may maintain a common subject matter. In some implementations, generality of common subject matter maintained by individual divisions may vary at individual levels of the individual hierarchy. By way of non-limiting example, the common subject matter of a continuous division at the bottom of the individual hierarchy (e.g., a subsection) may be more specific than the common subject matter of a continuous division higher within the hierarchy (e.g., a section). For example, a chapter included in an individual document may be higher on an individual hierarchy than a paragraph. For example, a common subject matter of the chapter may be more generalized than a common subject matter of the paragraph.

By way of non-limiting example, individual ones of the document may include one or more sections. By way of non-limiting example, the one or more sections included in an individual one of the documents may be organized into a set of one or more sections. Individual ones of the sections may include one or more subsections. The one or more sections included in an individual one of the sections may be organized into a set of one or more subsections. Individual ones of the subsections may be included in individual ones of the documents by virtue of being included in individual ones of the sections. In some implementations, individual ones of the subsections may include a sequence of text. In some implementations, individual ones of the subsections may not include an individual sequence of text. For example, individual subsections may include a graphic without text.

In some implementations, divisions at lower levels of an individual hierarchy may be subdivisions of divisions at higher levels of the individual hierarchy. By way of non-limiting example, subsections may be lower on an individual hierarchy than sections organized within the individual hierarchy. For example, one or more subsections included in an individual document may be subdivisions of an individual section included in an individual document.

By way of non-limiting example, an individual document may include one or more individual pages. Individual ones of the sections and/or individual ones of the subsections may be located on individual pages. One or more of the sections and/or one or more of the subsections may be located on an individual page. By way of non-limiting example, an individual continuous division may be located across one or more pages of an individual document. An individual document may be an electronic representation (such as, e.g., a scan) of a physical document and/or an electronic document. By way of non-limiting example, an individual document may be an electronic representation of a tax document, a financial document, a bank statement, a medical document, an identification document, a vehicle document, an academic document, and/or another type of document.

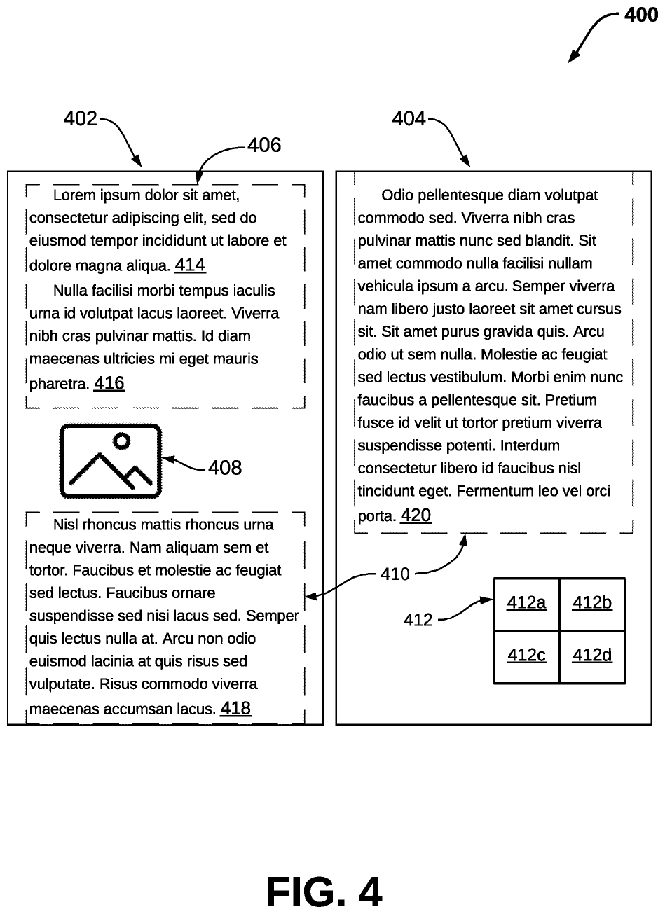

By way of non-limiting example, FIG. 4 illustrates a document 400. Document 400 may include a first page 402 and a second page 404. Document 400 may include a first section 406 and a second section 410. First section 406 may include a first paragraph 414 and a second paragraph 416. Second section 410 may include a third paragraph 418 and a fourth paragraph 420. By way of non-limiting example, second section 410 may be located on first page 402 and second page 404. Document 400 may include an image 408. Document 400 may include a table 412. Table 412 may include cells 412a-412b-412c-412d.

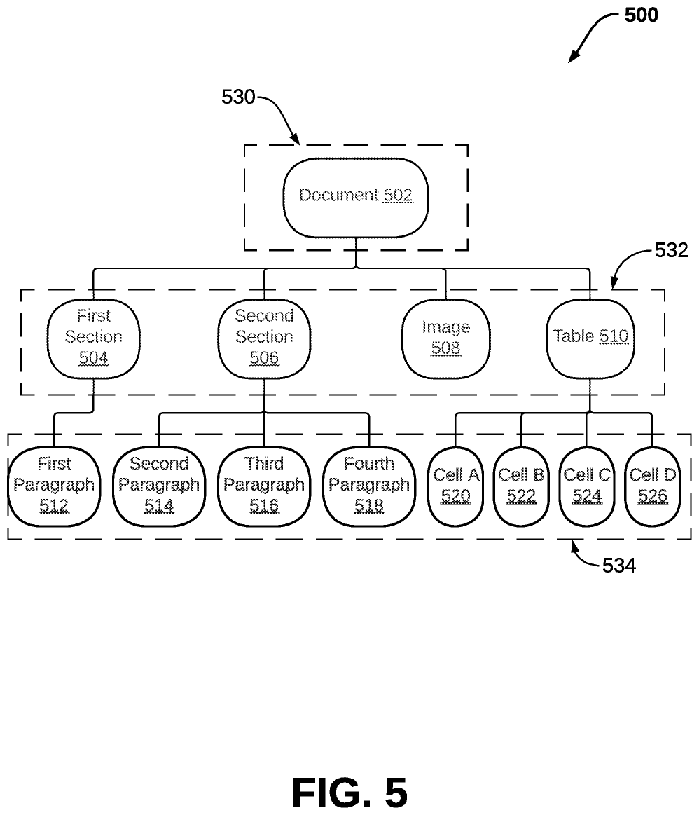

By way of non-limiting example, FIG. 5 illustrates a hierarchy 500. Hierarchy 500 may be a visual representation of hierarchical organization of an individual document. By way of non-limiting example, the individual document may be the same as or similar to document 400 depicted in FIG. 4. Hierarchy 500 may include a first level 530, a second level 532, and a third level 534. By way of non-limiting example, document 502 may be organized at first level 530. Document 502 may be the same as and/or similar to document 400 depicted in FIG. 4. First section 504, second section 506, image 508, and table 510 may be organized at second level 532. First section 504, second section 506, image 508, and table 510 may be the same as or similar to first section 406, second section 410, image 408, and table 412 depicted in FIG. 4, respectively. By way of non-limiting example, second level 532 may include sections, graphics, tables, charts, and/or other types of divisions. As such, second level 532 may include one or more types of divisions. First paragraph 512, second paragraph 514, third paragraph 516, fourth paragraph 518, cell A 520, cell B 522, cell C 524, and cell D 526 may be organized at a third level 534. By way of non-limiting example, third level 534 may include paragraphs, cells (e.g., from tables), and/or other types of divisions. First paragraph 512, second paragraph 514, third paragraph 516, fourth paragraph 518, cell A 520, cell B 522, cell C 524, and cell D 526 may be the same as or similar to first paragraph 414, second paragraph 416, third paragraph 418, fourth paragraph 420, cell 412a, cell 412b, cell 412c, and cell 412d depicted in FIG. 4. First paragraph 512 may be included in first section 504 in the individual document. Second paragraph 514, third paragraph 516, and fourth paragraph 518 may be included in second section 506 in the individual document. Cell A 520, cell B 522, cell C 524, and cell D 526 may be included in table 510 in the individual document. First paragraph 512, second paragraph 514, third paragraph 516, and fourth paragraph 518 may include individual sequences of text by virtue of being paragraphs. In some implementations, individual ones of cell A 520, cell B 522, cell C 524, and cell D 526 may include one or more of a graphic, a chart, a sequence of text, and/or other content.

Referring to FIG. 1, system 100 may include non-transitory electronic storage 128. Non-transitory electronic storage 128 may store one or more machine learning models 130. By way of non-limiting example, one or more machine learning models 130 may include embedding model(s) 132, comparison model(s) 134, extraction model(s) 136, segmentation model(s) 138, summarization model(s) 140, natural language model(s) 142, and/or other machine learning model(s). By way of non-limiting example, individual ones of the one or more machine learning models 130 may be based on a transformer architecture, a recurrent neural network architecture, a long short-term memory (LSTM) network architecture, an image classification model, an object detection model, an image segmentation model, an object landmark detection model, and/or another machine learning architecture. In some implementations, one or more machine learning models 130 may include a computer vision machine learning model, a natural language processing machine learning model, a large language model, and/or another type of machine learning model. One or more machine learning models 130 may be trained and/or pre-trained machine learning models.

Referring to FIG. 1, in some implementations, system 100 may include one or more servers 102, one or more client computing platforms 104, external resources 148, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of document component 108, segmentation component 110, semantic vector component 112, summary component 114, query component 120, summary traversal component 122, information extraction component 124, natural language component 126, and/or other instruction components.

Document component 108 may be configured to obtain one or more documents 146. By way of non-limiting example, one or more documents 146 may include a first document, a second document, and so forth. The first document may include a first set of sections. The first document may include individual sections included in the first set of sections. The first set of sections may include a first section, a second section, and so forth. The first section may include a first set of subsections. The first section may include individual subsections included in the first set of subsections. The first set of subsections may include a first subsection, a second subsection, and so forth. In some implementations, individual ones of the documents may be obtained from electronic storage 128, one or more client computing platforms 104, external resources 148, and/or from another source. By way of non-limiting example, a user may provide individual ones of one or more documents 146 (to at least one of one or more machine learning models 130) for summarization and/or information extraction via one or more client computing platforms 104.

Segmentation component 110 may be configured to identify individual sets of divisions of one or more division types included in individual ones of one or more documents 146. In some implementations, identifying divisions of one or more types may include identifying a hierarchical organization of individual ones of the one or more documents. In some implementations, segmentation component 110 may be configured to identify divisions included in individual documents for individual levels of the hierarchy into which the individual documents are organized. By way of non-limiting example, segmentation component 110 may be configured to identify one or more of sections, subsections, chapters, subchapters, paragraphs, charts, graphics, images, tables, lists, and/or other types of divisions included in individual documents.

In some implementations, segmentation component 110 may use at least one of one or more machine learning model(s) 130. By way of non-limiting example, segmentation component 110 may use one or more segmentation models 138. In some implementations, one or more segmentation models 138 may use natural language processing techniques, computer vision techniques, and/or other techniques for processing the one or more documents. By way of non-limiting example, one or more segmentation models 138 may be trained models. In some implementations, one or more segmentation models 138 may be configured to identify individual divisions of individual documents.

By way of non-limiting example, segmentation component 110 may be configured to identify individual sets of sections corresponding to individual ones of the one or more documents. By way of non-limiting example, a first set of sections from a first document may be identified. By way of non-limiting example, the first set of sections may be identified by one or more segmentation models 138. By way of non-limiting example, the sections included in the first set of sections may include chapters included in the first document.

By way of non-limiting example, segmentation component 110 may be configured to identify individual sets of subsections corresponding to individual sections included in the individual sets of sections. By way of non-limiting example, a first set of subsections for the first section may be identified. By way of non-limiting example, the first set of subsections may include paragraphs included in the first section.

Semantic vector component 112 may be configured to create individual sets of semantic vectors. By way of non-limiting example, a first set of semantic vectors including a first semantic vector may be created. In some implementations, individual semantic vectors may characterize semantic meanings of individual subsections and/or other types of divisions. By way of non-limiting example, semantic vectors may be created for divisions of individual documents organized at a particular level of individual hierarchies (e.g., at the bottom level). By way of non-limiting example, the first semantic vector may characterize semantic meaning of a first subsection.

In some implementations, semantic vector component 112 may use at least one of one or more machine learning models 130 to create the individual sets of semantic vectors. By way of non-limiting example, semantic vector component 112 may use embedding model(s) 132. By way of non-limiting example, embedding model(s) 132 models may be configured to convert natural language to vector embeddings with semantic meaning. In some implementations, embedding model(s) 132 may be configured to convert token embeddings representing natural language to semantic vectors. In some implementations, individual semantic vectors may include numeric vectors associated with individual sequences of text. By way of non-limiting illustration, the use of numeric vectors to represent semantic meanings of sequences of text may enable one or more computer processors to compare sequences of text in accordance with semantic meanings of the sequences of text. The numeric vectors may be associated with the individual sequences in accordance with semantic meanings of the individual sequences of text. Individual numeric vectors included in individual semantic vectors may be normalized. In some implementations, normalizing the individual numeric vectors may include multiplying individual numeric vectors by a factor that makes a quantity associated with the individual numeric vectors (e.g., an integral) equal to a desired value (e.g., 1).

In some implementations, creating an individual semantic vector associated with an individual subsection may include dividing an individual sequence of text included in an individual subsection into individual tokens. In some implementations, dividing the individual sequence of text into individual tokens may be done by embedding model(s) 132, another model, a user, another entity, and/or another system. By way of non-limiting example, embedding model(s) 132 may be configured to take individual sequences of text as input.

Dividing an individual sequence of text into individual tokens may be the same as or similar to tokenization. Tokenization may include separating the individual sequence of text into smaller units, or individual tokens. Tokens may comprise words, characters, sub-words, punctuation, and/or other portions of the individual sequence of text. In some implementations, particular tokens may be used to denote sentence structure and/or other information. Tokenizing an individual sequence of text may enable and/or make it easier for embedding model(s) 132 to attribute semantic meaning to the individual sequence of text. By way of non-limiting example, the particular tokens may characterize a beginning of a sentence, an end of a sentence, padding (e.g., such that tokenization results in a particular number of tokens), an unknown character, an unknown string of characters, and/or other information. By way of non-limiting example, the sequence of text “Let's discuss embeddings” may be tokenized. Thus, the sequence of text “Let's discuss tokens and embeddings” may be divided into a sequence of individual tokens. The sequence of individual tokens may include “Let,”, “s,” “discuss,” “em,” “##bed,” “##ding,” and “s.” By way of non-limiting example, double hash signs (“##”) may be used to denote division of an individual word into tokens. In some implementations, the sequence of individual tokens may include one or more other tokens characterizing a beginning of a sentence, an end of a sentence, a division within a word, padding, and/or other information. By way of non-limiting, a first sequence of text included in the first subsection may be divided into a first set of tokens. In some implementations, the first set of tokens may be ordered.

In some implementations, creating the individual semantic vector may include determining token embeddings. An individual token embedding may represent semantic meaning of an individual token. By way of non-limiting example, token embeddings may be determined based on semantic meaning of individual tokens. For example, the sequences of individual tokens for “riverbank” and “bank robber” may both include the token “bank.” The token embedding for “bank” as in “riverbank” may be different than the token embedding for “bank” as in “bank robber.” For example, different words having similar meanings may have a smaller semantic distance (or more similarity) than unrelated words. For example, “fruit” and “juice” may have a smaller semantic distance than “tricycle” and “goldfish”. In some implementations, semantic distance may be determined based on similarity between vectors (e.g., token embeddings) as determined by inner product, cosine similarity, Euclidean distance, Jaccard similarity, Manhattan similarity, and/or another similarity metric. In some implementations, determining the token embeddings may be done by embedding model(s) 132, another model, a user, another entity, and/or another system. In some implementations, embedding model(s) 132 may be configured to take as input a sequence of individual tokens. By way of non-limiting example, a first set of token embeddings may be determined for the first set of tokens.

In some implementations, determining individual semantic vectors may include aggregating token embeddings pertaining to individual sequences of text to generate aggregated token embeddings. In some implementations, aggregating the token embeddings may include determining and/or obtaining output token embeddings from embedding model(s) 132. In some implementations, creating the individual semantic vector may include generating the individual semantic vector based on an aggregated token embedding. In some implementations, the token embeddings may be aggregated multiple times to generate an individual semantic vector. For example, token embeddings may be aggregated for the sentences included in the first sequence of text to generate sentence embeddings for the first sequence of text. For example, the sentence embeddings for the first sequence of text may be aggregated to generate the first semantic vector. By way of non-limiting example, determining a first semantic vector characterizing semantic meaning of the first subsection may include aggregating the first set of token embeddings.

Semantic vector component 112 may be configured to store semantic vectors and/or other information in vector database 144 and/or other storage, including but not limited to electronic storage 128. For example, semantic vector component 112 may store semantic vectors (e.g., as determined by semantic vector component 112 and/or at least one of one or more machine learning models 130) in vector database 144.

Summary component 114 may be configured to generate summaries of individual divisions included in one or more documents 146. In some implementations, summary component 114 may be configured to summarize divisions at one or more levels of individual hierarchies into which one or more documents 146 are organized. By way of non-limiting example, summary component 114 may be configured to summarize a document, chapters included in the document, subchapters included in the document, paragraphs included in the document, and/or other divisions included in the document. In some implementations, the summaries may be in the form of summary vectors. Summary vectors may include numeric vectors associated with individual sequences of text. By way of non-limiting illustration, the use of numeric vectors to represent semantic meanings of sequences of text may enable one or more computer processors to compare sequences of text in accordance with semantic meanings of the sequences of text. The numeric vectors may be associated with the individual summaries in accordance with semantic meanings of the individual summaries. Individual numeric vectors included in individual summary vectors may be normalized. In some implementations, normalizing the individual numeric vectors may include multiplying individual numeric vectors by a factor that makes a quantity associated with the individual numeric vectors (e.g., an integral) equal to a desired value (e.g., 1). By way of non-limiting example, individual summary vectors may be generated for none, some, and/or all of the individual continuous divisions at individual levels of one or more individual hierarchies.

In some implementations, summary component 114 may use at least one of one or more machine learning models 130. By way of non-limiting example, summary component 114 may use one or more summarization models 140. One or more summarization models 140 may be configured to summarize sequences of text and/or summarizations of one or more sequences of text. By way of non-limiting example, one or more summarization models 140 may be configured to take sequences of text, semantic vectors, a vector characterizing semantic meaning of a summarization of individual divisions, and/or other representations of divisions of documents as input. In some implementations, one or more summarization models 140 may be configured to generate summarizations of the input. Summary component 114 may be configured to provide sequences of text, semantic vectors, a vector characterizing semantic meaning of a summarization of individual divisions, and/or other representations of divisions of documents as input for one or more summarization models 140. Summary component 114 may be configured to obtain output from one or more summarization models 140. By way of non-limiting example, the summarizations may be in the form of a vector characterizing semantic meaning of a summarization of the input and/or a natural language summarization of semantic meaning of the input.

In some implementations, summary component 114 may generate summaries of individual divisions recursively through individual levels of individual hierarchies into which one or more documents 146 are organized. In some implementations, summaries may be generated for individual divisions beginning with lower levels of the individual hierarchies. In some implementations, the summaries may be generated such that summaries for divisions organized at higher levels of the individual hierarchies are generated after and/or using summaries for divisions organized at lower levels of the individual hierarchies. In some implementations, generating summaries for divisions organized at individual levels of an individual hierarchy (e.g., divisions organized at a bottom level of an individual hierarchy) may include providing semantic vectors characterizing semantic meaning of the divisions and/or individual sequences of text included in the divisions as input for one or more summarization models 140, at least one of one or more machine learning models 130, and/or another system configured to generate summarizations of divisions included in individual documents. In some implementations, generating summaries for divisions not organized at the bottom level of an individual hierarchy may include providing summaries for divisions organized at a lower level of the individual hierarchy as input for one or more summarization models 140, at least one of one or more machine learning models 130, and/or another system configured to generate summarizations of divisions included in individual documents. By way of non-limiting example, a first division may include a first set of divisions. The first division may be organized at a higher level of a first hierarchy than individual ones of the first set of divisions. A first set of summaries may have been generated for the first set of divisions. In some implementations, generating a summary of the first division may include providing the first set of summaries as input for one or more summarization models 140, at least one of one or more machine learning models 130, and/or another system configured to generate summarizations of divisions included in individual documents.

By way of non-limiting example, summary component 114 may be configured to generate individual sets of subsection summary vectors in accordance with the individual sets of semantic vectors. Generating individual sets of subsection summary vectors may include generating individual subsection summary vectors for individual semantic vectors. By way of non-limiting example, a first set of subsection summary vectors including a first subsection summary vector may be generated in accordance with the first set of semantic vectors. In some implementations, individual subsection summary vectors may summarize semantic meaning of individual subsections. By way of non-limiting example, the first subsection summary vector may summarize semantic meaning of the first subsection. In some implementations, individual subsection summary vectors may be generated using one or more summarization models 140, at least one of one or more machine learning models 130, and/or another system configured to generate summarizations of divisions included in individual documents.

By way of non-limiting example, summary component 114 may be configured to generate individual sets of section summary vectors in accordance with the individual sets of subsection summary vectors. In some implementations, individual section summary vectors may summarize semantic meaning of individual sections. By way of non-limiting example, a first section summary vector may be generated in accordance with the first set of subsection summary vectors. The first section summary vector may summarize semantic meaning of the first section. In some implementations, individual section summary vectors may be generated using one or more summarization models 140, at least one of one or more machine learning models 130, and/or another system configured to generate summarizations of divisions included in individual documents.

Summary component 114 may be configured to generate individual document summary vectors in accordance with the individual sets of section summary vectors. In some implementations, individual document summary vectors may summarize semantic meaning of individual documents. By way of non-limiting example, a first document summary vector may be generated in accordance with the first set of section summary vectors. The first document summary vector may summarize semantic meaning of the first document. In some implementations, individual document summary vectors may be generated using one or more summarization models 140, at least one of one or more machine learning models 130, and/or another system configured to generate summarizations of divisions included in individual documents.

In some implementations, summary component 114 may be configured to associate a topic with individual sets of summary vectors. In some implementations, the topic may be associated with a keyword. In some implementations, summary component 114 may be configured to augment individual summary vectors to include information characterizing individual keywords associated with individual topics associated with the individual summary vectors and/or the individual topics.

Query component 120 may be configured to obtain a query from a user. In some implementations, a particular user 127 may input the query via one or more user interface(s) 154 presented on one or more client computing platforms 104. In some implementations, the particular user 127 may select one or more documents 146, including but not limited to a set of exemplary documents. In some implementations, one or more documents 146 may be provided as input to extract information, e.g., from a particular corpus of electronic documents. By way of non-limiting example, the query may be related to information included in one or more documents 146. Query component 120 may be configured to divide the query into individual tokens. Query component 120 may be configured to determine individual token embeddings for the individual tokens. Query component 120 may be configured to aggregate the individual token embeddings to generate an aggregated token embedding.

Query component 120 may be configured to generate a query vector. In some implementations, the query vector may be a vector characterizing semantic meaning of the query. In some implementations, query component 120 may be configured to use at least one of one or more machine learning models 130, one or more embedding models 132, and/or another system to generate vectors characterizing semantic meaning of a sequence of text. Query component 120 may be configured to provide the aggregated token embedding as input for at least one of one or more machine learning models 130, one or more embedding models 132, and/or another system to generate vectors characterizing semantic meaning of a sequence of text. Query component 120 may be configured to obtain a query vector from at least one of one or more machine learning models 130, one or more embedding models 132, and/or another system to generate vectors characterizing semantic meaning of a sequence of text based on the input. In some implementations, the process of generating a query vector based on a query may be the same as or similar to the process for creating an individual semantic vector for an individual division of a document (e.g., as done using semantic vector component 112).

Summary traversal component 122 may be configured to recursively traverse through one or more hierarchies into which one or more documents 146 are organized. By way of non-limiting example, summary traversal component 122 may be configured to identify individual divisions likely to include information pertaining to the query. In some implementations, summary traversal component 122 may traverse through some or all of the divisions included in an individual document. In some implementations, summary traversal component 122 may not traverse through divisions included in an individual document determined to be unlikely to include information pertaining to the query.

Summary traversal component 122 may be configured to identify one or more individual sets of divisions organized at individual levels of individual hierarchies into which one or more documents 146 are organized. In some implementations, summary traversal component 122 may be configured to traverse through an individual hierarchy from a top level of the individual hierarchy to a bottom level of the individual hierarchy. By way of non-limiting example, determining an individual set of divisions at a second level of an individual hierarchy may be based on a determined set of divisions at a first level of the individual hierarchy. For example, the first level may be a higher level on the hierarchy than the second level. As such, individual divisions organized at the second level of the hierarchy may be included in individual ones of the divisions organized at the first level. By way of non-limiting example, only divisions organized at the second level and included in individual ones of the divisions included in the determined set of divisions at the first level may be considered for inclusion in the individual set of divisions at the second level.

In some implementations, one or more sets of divisions organized at a given level may be determined. By way of non-limiting example, the determined set of divisions organized at the first level may include a first division. In some implementations, one or more sets of divisions organized at the second level may be determined. The one or more sets of divisions may individually correspond to individual divisions organized at the first level. By way of non-limiting example, the one or more sets of divisions organized at the second level may include a first set of divisions corresponding to the first division. For example, individual ones of the divisions included in the first set of divisions may be included in the first division.

Identifying individual sets of divisions may be based on one or more comparisons of a query vector to a semantic vector and/or a summary vector. Individual ones of the comparisons may be of a first type of comparisons, a second type of comparisons, and/or other types of comparisons. For example, a first type of comparison may compare a query vector with one or more semantic vectors (e.g., as stored in vector database 135) and/or summary vectors (e.g., as stored in vector database 135). In some implementations, such a comparison may be based on one or both of semantic distance and/or (cosine) similarity. As another example, a second type of comparisons may use keyword matching and/or keyword searching, in which two words need to match verbatim and/or to the letter. By way of non-limiting example, the second type of comparison may be used to identify a keyword associated with a particular topic is included in an individual summary vector of a division included in one or more documents 146. By way of non-limiting example, measuring similarity between vectors may include calculating inner product, cosine similarity, Euclidean distance, Jaccard similarity, Manhattan similarity, and/or another similarity metric. In some implementations, another type of comparison used for determinations by summary traversal component 122 may be based on relative positioning of a corresponding document segment within a particular set of documents. For example, a document segment adjacent to another document segment that was previously selected (e.g., based on the first or second type of comparisons) may be an important document segment for determinations by summary traversal component 122.

In some implementations, summary traversal component 122 may be configured to use one or more comparison models 134, at least one of one or more machine learning models 130, and/or another system for comparing a query vector with a semantic vector and/or a summary vector. In some implementations, one or more comparison models 134 may be configured to compare vectors characterizing semantic meaning of individual sequences of text.

By way of non-limiting example, summary traversal component 122 may be configured to determine and/or select a subset of one or more documents 146. By way of non-limiting example, determining the subset of the one or more documents 146 may be based on one or more comparisons between the query vector and the individual document summary vectors included in the set of document summary vectors (e.g., as generated using summary component 114).

By way of non-limiting example, summary traversal component 122 may be configured to determine and/or select a set of sections. In some implementations, individual sections included in the set of sections may be included in individual documents included in the subset of the one or more documents. By way of non-limiting example, determining the set of sections may be based on a comparison between the query vector and individual selected section summary vectors summarizing semantic meanings of individual sections included in individual ones of the subset of the one or more documents. In some implementations, the individual selected subsection summary vectors may be included in the individual sets of subsection summary vectors (e.g., as generated using summary component 114).

In some implementations, summary traversal component 122 may be configured to determine and/or select one or more sets of divisions organized at a bottom level of one or more hierarchies into which one or more documents 146 are organized. In some implementations, the sets of divisions may be determined using summary vectors for individual ones of the divisions. By virtue of individual ones of the divisions being organized at a bottom level of the one or more hierarchies, the individual ones of the divisions may be associated with individual semantic vectors (e.g., as stored in vector database 144) characterizing semantic meaning of the individual ones of the divisions.

By way of non-limiting example, summary traversal component 122 may be configured to determine and/or select a set of subsections. In some implementations, the subsections included in the set of subsections may be included in individual ones of the sections included in the set of sections. By way of non-limiting example, determining the set of subsections may be based on a comparison between the query vector and individual selected subsection summary vectors summarizing semantic meanings of individual subsections included in individual ones of the set of sections. In some implementations, individual selected subsection summary vectors may be included in the individual sets of subsection summary vectors (e.g., as generated using summary component 114).

In some implementations, summary traversal component 122 may be configured to include individual subsections adjacent within the one or more documents to one or more individual ones of the subsections included in the set of subsections. By way of non-limiting example, adjacent subsections may be included in the set of subsections as they may include information pertinent to the query. Including adjacent sections may increase the likelihood that information pertinent to the query is included in the set of subsections.

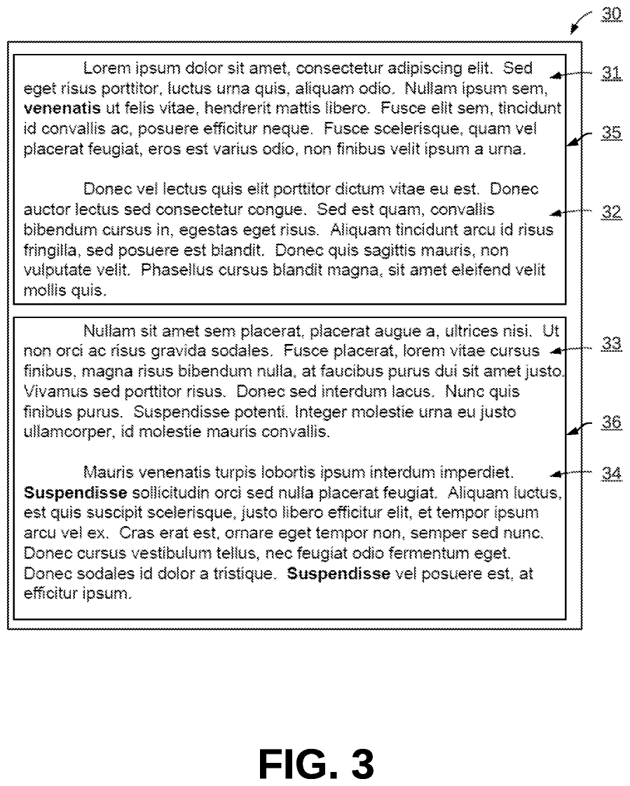

By way of non-limiting example, FIG. 3 illustrates an exemplary page 30 of an exemplary document as may be used in system 100 (of FIG. 1), in accordance with one or more implementations. As depicted, exemplary page 30 includes a first section 35 and a second section 36. As depicted, exemplary page 30 includes a first paragraph 31, a second paragraph 32, a third paragraph 33, and a fourth paragraph 34. First section 35 may include first paragraph 31 and second paragraph 32. Second section 36 may include third paragraph 33 and fourth paragraph 34. In some cases, individual sections and/or individual paragraphs may be individual divisions (e.g., as created by segmentation component 110). Alternatively, and/or simultaneously, individual sentences within a paragraph may be individual divisions (e.g., as created by segmentation component 110). For example, first paragraph 31 may include five sentences. Exemplary page 30 may contain prose, narrative, and/or other natural language. In some cases, contents similar in type to exemplary page 30 may be suitable for natural language searching. Summary vectors may have been generated for exemplary page 30, first section 35, second section 36, first paragraph 31, second paragraph 32, third paragraph 33, and fourth paragraph 34.

By way of non-limiting example, summary vectors for first section 35 and first paragraph 31 may include a numeric representation of the word “venenatis” (from the Latin word for poisonous). A suitable type of comparison for similar content may be the first type of comparison as performed by summary traversal component 122 as depicted in FIG. 1. For example, if a query is about “danger”, or “deadly”, or “poison”, the word “venenatis” in a summary vector for first section 35 would be relevant. By way of non-limiting example, document segments that include this word (such as, by way of non-limiting example, the third sentence of first paragraph 31) may be relevant. As such, a set of sections as determined by summary traversal component 122 may include first section 35. By virtue of first section 35 being included in the set of sections, summary traversal component 122 may compare summary vectors for first paragraph 31 and second paragraph 32 to a query vector characterizing semantic meaning of the query. First paragraph 31 may be included in a set of paragraphs included in first section 35 determined by summary traversal component 122. In some cases, adjacent paragraphs or document segments (such as, by way of non-limiting example, second paragraph 32) may be relevant. As such, second paragraph 32 may be included in the set of paragraphs included in first section 35.

As another example in FIG. 3A, summary traversal component 122 may perform the second type of comparison, for a keyword search, for (part of) exemplary page 30. For example, if a query pertains to the term “suspendisse”, second section 26 and fourth paragraph 34 contain two instances of exactly that word, in its second sentence and its last sentence. For keyword searching, fewer and/or different document segments may be relevant. Summary traversal component 122 may include second section 36 in the set of sections. By virtue of second section 36 being included in the set of sections, summary traversal component 122 may compare summary vectors for third paragraph 33 and fourth paragraph 34 to the query vector. Fourth paragraph 34 may be included in a set of paragraphs included in second section 36 as determined by summary traversal component 122.

Referring to FIG. 1, information extraction component 124 may be configured to provide a prompt to at least one of the one or more machine learning models 130. In some implementations, the prompt may be based on the query (e.g., as obtained by query component 120). By way of non-limiting example, the at least one of the one or more machine learning models 130 may include one or more extraction models 136 and/or other systems for extracting information from divisions included in individual documents. In some implementations, one or more extraction models 136, at least one of one or more machine learning models 130, and/or another system may be configured to generate a vector characterizing semantic meaning of a response to a prompt. In some implementations, the vector may be generated based on one or more vectors characterizing semantic meaning of sequences of text provided as context to one or more extraction models 136, at least one of one or more machine learning models 130, and/or another system. Information extraction component 124 may be configured to provide a set of one or more semantic vectors (e.g., as stored in vector database 144) as context for one or more extraction models 136, at least one of one or more machine learning models 130, and/or another system. In some implementations, individual ones of the set of semantic vectors may characterize individual semantic meanings of a set of individual divisions organized at a bottom level of individual hierarchies (e.g., as determined by summary traversal component 122). By way of non-limiting example, individual semantic vectors characterizing individual semantic meanings of individual subsections included in the determined set of subsections (e.g., as determined by summary traversal component 122) may be provided as context for one or more extraction models 136, at least one of one or more machine learning models 130, and/or another system.

Information extraction component 124 may be configured to obtain one or more replies from one or more extraction models 136, at least one of one or more machine learning models 130, and/or another system. In some implementations, the one or more replies may be in reply to the prompt. In some implementations, the one or more replies may be based on the context provided to one or more extraction models 136, at least one of one or more machine learning models 130, and/or another system. Information extraction component 124 may be configured to present the one or more replies obtained from one or more extraction models 136, at least one of one or more machine learning models 130, and/or another system. In some implementations, the one or more replies may be presented to a particular user 127 via one or more user interfaces 154 on one or more client computing platforms 104. In some implementations, the one or more replies may include a numeric vector characterizing semantic meaning of an answer to the prompt. In some implementations, presenting the one or more replies may include generating a natural language representation of the one or more replies. In some implementations, the one or more replies returned by one or more extraction models 136, at least one of one or more machine learning models 130, and/or another system may be natural language replies.

As used herein, the term “extract” and its variants refer to the process of identifying and/or interpreting information that is included in one or more documents, whether performed by determining, measuring, calculating, computing, estimating, approximating, interpreting, generating, and/or otherwise deriving the information, and/or any combination thereof. In some implementations, extracted information may have a semantic meaning, including but not limited to opinions, judgement, classification, and/or other meaning that may be attributed to (human and/or machine-powered) interpretation. For example, in some implementations, some types of extracted information need not literally be included in a particular electronic source document, but may be a conclusion, classification, and/or other type of result of (human and/or machine-powered) interpretation of the contents of the particular electronic source document. In some implementations, the extracted information may have been extracted by one or more extraction engines. For example, a particular extraction engine (referred to as an Optical Character Recognition engine or OCR engine) may use a document analysis process that includes optical character recognition (OCR). For example, a different extraction engine (referred to as a line engine) may use a different document analysis process that includes line detection. For example, another extraction engine (referred to as a barcode engine) may use a document analysis process that includes detection of barcodes, Quick Response (QR) codes, matrices, and/or other machine-readable optical labels. Alternatively, and/or simultaneously, in some implementations, the extracted information may have been extracted by a document analysis process that uses machine-learning (in particular deep learning) techniques. For example, (deep learning-based) computer vision technology may have been used. For example, a convolutional neural network may have been trained and used to classify (pixelated) image data as characters, photographs, diagrams, media content, and/or other types of information. In some implementations, the extracted information may have been extracted by a document analysis process that uses a pipeline of steps for object detection, object recognition, and/or object classification. In some implementations, the extracted information may have been extracted by a document analysis process that uses one or more of rule-based systems, regular expressions, deterministic extraction methods, stochastic extraction methods, and/or other techniques. In some implementations, particular document analysis processes that were used to extract the extracted information may fall outside of the scope of this disclosure, and the results of these particular document analysis processes, e.g., the extracted information, may be obtained and/or retrieved by a component of system 100.

Natural language component 126 may be configured to generate natural language summarizations of individual divisions included in one or more documents 146. In some implementations, the natural language summarizations may be generated based on summary vectors (e.g., as generated by summary component 114). In some implementations, natural language component 126 may be configured to use one or more natural language models 142, at least one of one or more machine learning models 130, and/or another system. In some implementations, one or more natural language models 142 may be configured to take as input vectors characterizing semantic meaning of individual sequences of text. One or more natural language models 130 may be configured to create sequences of text based on the input vectors. Natural language component 126 may be configured to provide the summary vectors as input to one or more natural language models 142. Natural language component 126 may be configured to obtain sequences of text created by one or more natural language models 142 based on the input.

By way of non-limiting example, natural language component 126 may be configured to generate individual natural language summarizations of individual semantic meanings of individual documents based on individual document summary vectors. By way of non-limiting example, a first natural language document summarization of semantic meaning of the first document may be generated based on the first document summary vector. By way of non-limiting example, natural language component 126 may be configured to generate individual natural language summarizations of individual sections based on individual section summary vectors. By way of non-limiting example, a first natural language section summarization of semantic meaning of the first section may be generated based on the first section summary vector. By way of non-limiting example, natural language component 126 may be configured to generate individual natural language summarizations of individual semantic meanings of individual subsections based on individual subsection summary vectors. By way of non-limiting example, a first natural language subsection summarization of semantic meaning of the first subsection may be generated based on the first subsection summary vector. In some implementations, individual natural language summarizations for individual documents, individual sections, individual subsections, and/or other divisions of individual documents may be generated using one or more natural language models 142, at least one of the one or more machine learning models 130, and/or another system.

In some implementations, server(s) 102, client computing platform(s) 104, and/or external resources 148 may be operatively linked via one or more electronic communication links. For example, such electronic communication links may be established, at least in part, via one or more (electronic communication) networks 150 such as the Internet and/or other networks. It will be appreciated that this is not intended to be limiting, and that the scope of this disclosure includes implementations in which server(s) 102, client computing platform(s) 104, and/or external resources 148 may be operatively linked via some other communication media.

A given client computing platform 104 may include one or more processors configured to execute computer program components. The computer program components may be configured to enable an expert or user associated with the given client computing platform 104 to interface with system 100 and/or external resources 148, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms. By interfacing with system 100, the one or more processors configured to execute the computer program modules of the given client computing platform 104 may improve functionality of the given client computing platform 104 such that the given client computing platform 104 functions more than a generic client computing platform thereon out. Upon interfacing with system 100, a computer-automated process may be established and/or improved of the given client computing platform 104.

External resources 148 may include sources of information outside of system 100, external entities participating with system 100, and/or other resources. For example, in some implementations, external resources 148 may include one or more servers configured to provide computational resources that may be used to train extraction model 132. In some implementations, some or all of the functionality attributed herein to external resources 148 may be provided by resources included in system 100.

Server(s) 102 may include electronic storage 128, one or more processors 152, and/or other components. Server(s) 102 may include communication lines, or ports to enable the exchange of information with a network (e.g., one or more networks 150) and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may include non-transitory storage media that electronically stores one or more documents 146, a vector database 144, one or more machine learning models 130, and/or other information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store training information, software algorithms, information determined by processor(s) 152, information received from server(s) 102, information received from client computing platform(s) 104, and/or other information that enables server(s) 102 to function as described herein.

Processor(s) 152 may be configured to provide information processing capabilities in server(s) 102. As such, processor(s) 152 may include one or more of a digital processor, an analog processor, a digital circuit designed to process information, an analog circuit designed to process information, a state machine, and/or other mechanisms for electronically processing information. These mechanisms for electronically processing information that may serve as processor(s) 152 may transform and/or improve server(s) 102 such that server(s) 102 function to accomplish a specific purpose. Although processor(s) 152 is shown in FIG. 1 as a single entity, this is for illustrative purposes only. In some implementations, processor(s) 152 may include a plurality of processing units. These processing units may be physically located within the same device, or processor(s) 152 may represent processing functionality of a plurality of devices operating in coordination. Processor(s) 152 may be configured to execute components 108, 110, 112, 114, 120, 122, 124, 126, and/or other components. Processor(s) 152 may be configured to execute components 108, 110, 112, 114, 120, 122, 124, 126, and/or other components by software; hardware; firmware; some combination of software, hardware, and/or firmware; and/or other mechanisms for configuring processing capabilities on processor(s) 152. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 120, 122, 124, and 126 are illustrated in FIG. 1 as being implemented within a single processing unit, in implementations in which processor(s) 152 includes multiple processing units, one or more of components 108, 110, 112, 114, 120, 122, 124, and/or 126 may be implemented remotely from the other components. The description of the functionality provided by the different components 108, 110, 112, 114, 120, 122, 124, and/or 126 described below is for illustrative purposes, and is not intended to be limiting, as any of components 108, 110, 112, 114, 120, 122, 124, and/or 126 may provide more or less functionality than is described. For example, one or more of components 108, 110, 112, 114, 120, 122, 124, and/or 126 may be eliminated, and some or all of its functionality may be provided by other ones of components 108, 110, 112, 114, 120, 122, 124, and/or 126. As another example, processor(s) 152 may be configured to execute one or more additional components that may perform some or all of the functionality attributed below to one of components 108, 110, 112, 114, 120, 122, 124, and/or 126.

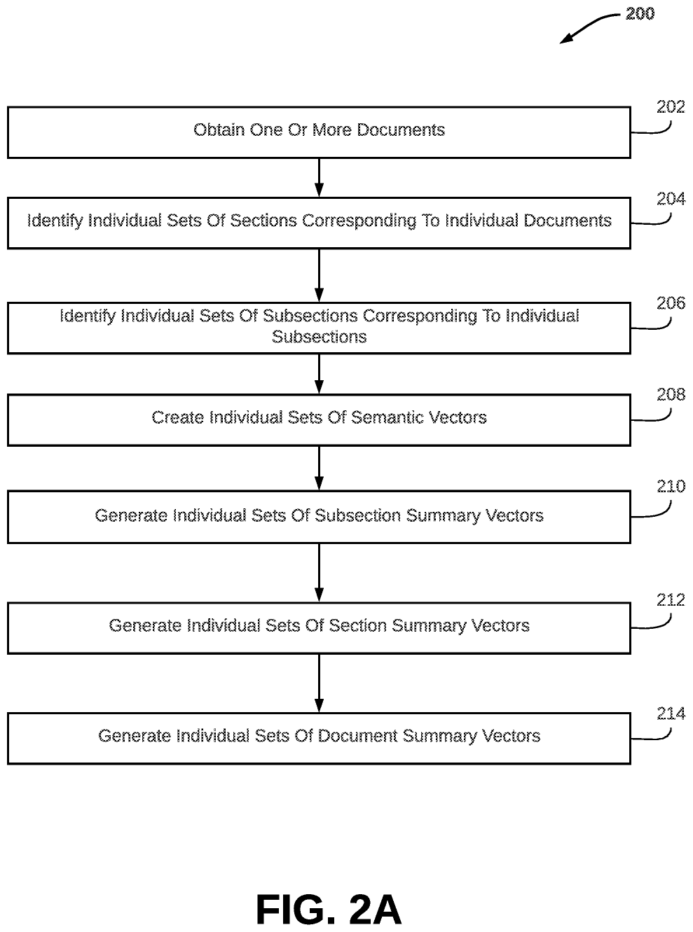

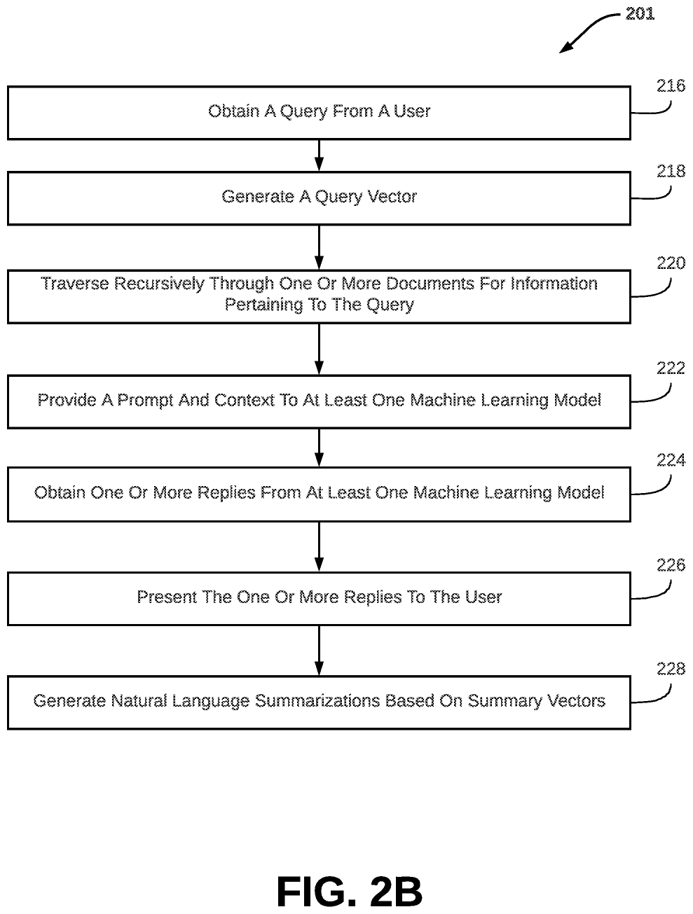

FIGS. 2A and 2B illustrate methods 200 and 201 to use one or more machine learning models to summarize a set of one or more documents, in accordance with one or more implementations. The operations of methods 200 and 201 presented below are intended to be illustrative. In some implementations, methods 200 and 201 may be accomplished with one or more additional operations not described, and/or without one or more of the operations discussed. Additionally, the order in which the operations of methods 200 and 201 are illustrated in FIGS. 2A and 2B and described below is not intended to be limiting.

In some implementations, methods 200 and 201 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 200 and 201 in response to instructions stored electronically on an electronic storage medium. The one or more processing devices may include one or more devices configured through hardware, firmware, and/or software to be specifically designed for execution of one or more of the operations of methods 200 and 201.

Regarding method 200 (depicted in FIG. 2A), an operation 202 may include obtaining one or more documents including a first document. By way of non-limiting example, the first document may include one or more sections including a first section. The first section may include one or more subsections including a first subsection. Individual ones of the one or more subsections may be arranged in a particular order. Individual ones of the one or more subsections included in the first section may be subsections within the first document. The first subsection may include one or more sequences of text including a first sequence of text. Operation 202 may be performed by a component that is the same as or similar to document component 108 (shown in FIG. 1), in accordance with one or more implementations.

An operation 204 may include identifying individual sets of sections corresponding to individual ones of the one or more documents. In some implementations, identifying the individual sets may be done using at least one of the one or more machine learning models. By way of non-limiting example, a first set of sections from the first document may be identified. The first document may include individual sections included in the first set of sections. The first set of sections may include the first section. Operation 204 may be performed by a component that is the same as or similar to segmentation component 110 (shown in FIG. 1), in accordance with one or more implementations.

An operation 206 may include identifying individual sets of subsections corresponding to individual sections included in the individual sets of sections. In some implementations, identifying the individual sets may be done using at least one of the one or more machine learning models. By way of non-limiting example, a first set of subsections for the first section may be identified. The first set of subsections may include the first subsection. Operation 206 may be performed by a component that is the same as or similar to segmentation component 110 (shown in FIG. 1), in accordance with one or more implementations.

An operation 208 may include creating individual sets of semantic vectors using at least one of the one or more machine learning models. By way of non-limiting example, a first set of semantic vectors including a first semantic vector may be created. Individual semantic vectors may characterize semantic meanings of individual subsections. The first semantic vector may characterize semantic meaning of the first subsection. Operation 208 may be performed by a component that is the same as or similar to semantic vector component 112 (shown in FIG. 1), in accordance with one or more implementations.

An operation 210 may include generating individual sets of subsection summary vectors using at least one of the one or more machine learning models. In some implementations, the individual sets of subsection summary vectors may be generated in accordance with the individual sets of semantic vectors. By way of non-limiting example, a first set of subsection summary vectors including a first subsection summary vector may be generated in accordance with the first set of semantic vectors. Individual subsection summary vectors may summarize semantic meaning of individual subsections. By way of non-limiting example, the first subsection summary vector may summarize semantic meaning of the first subsection. Operation 210 may be performed by a component that is the same as or similar to summary component 114 (shown in FIG. 1), in accordance with one or more implementations.

An operation 212 may include generating individual sets of section summary vectors using at least one of the one or more machine learning models. In some implementations, the individual sets of section summary vectors may be generated in accordance with the individual sets of subsection summary vectors. By way of non-limiting example, a first section summary vector may be generated in accordance with the first set of subsection summary vectors. In some implementations, individual section summary vectors may summarize semantic meaning of individual sections. By way of non-limiting example, the first section summary vector may characterize semantic meaning of the first section. Operation 212 may be performed by a component that is the same as or similar to summary component 114 (shown in FIG. 1), in accordance with one or more implementations.

An operation 214 may include generating individual document summary vectors using at least one of the one or more machine learning models. In some implementations, the individual sets of section summary vectors may be generated in accordance with the individual sets of section summary vectors. By way of non-limiting example, a first document summary vector may be generated in accordance with the first set of section summary vectors. In some implementations, individual document summary vectors may summarize semantic meaning of individual documents. By way of non-limiting example, the first document summary vector may summarize semantic meaning of the first document. Operation 214 may be performed by a component that is the same as or similar to summary component 114 (shown in FIG. 1), in accordance with one or more implementations.

Regarding method 201 (depicted in FIG. 2B), an operation 216 may include obtaining a query from a user. Operation 216 may be performed by one or more hardware processors configured by machine-readable instructions including a component that is the same as or similar to query component 120 (shown in FIG. 1), in accordance with one or more implementations.

An operation 218 may include generating a query vector characterizing semantic meaning of the query. In some implementations, generating the query vector may include dividing the query into individual tokens. Operation 218 may include determining individual token embeddings for the individual tokens. Operation 218 may include aggregating the individual token embeddings to generate an aggregated token embedding. Operation 218 may include providing the aggregated token embedding as input for at least one of the one or more machine learning models. In some implementations, the at least one of the one or more machine learning models may be configured to receive token embeddings as input and to generate vectors characterizing semantic meaning of individual sequences of text. Operation 218 may be performed by one or more hardware processors configured by machine-readable instructions including a component that is the same as or similar to query component 120 (shown in FIG. 1), in accordance with one or more implementations.

An operation 220 may include traversing recursively through one or more documents for information pertaining to the query. Operation 220 may include determining a subset of the one or more documents. In some implementations, determining the subset of the one or more documents may be based on a comparison between the query vector and the individual document summary vectors included in the set of document summary vectors.

Operation 220 may include determining a set of sections using at least one of the one or more machine learning models. In some implementations, the sections included in the set of sections may be included in the documents included in the subset of the one or more documents. Determining the set of sections may be based on a comparison between the query vector and individual selected section summary vectors summarizing semantic meanings of individual sections included in individual ones of the subset of the one or more documents. In some implementations, the individual selected section summary vectors may be included in the individual sets of section summary vectors.

Operation 220 may include determining a set of subsections. In some implementations, the subsections included in the set of sections may be included in the sections included in the set of sections. Determining the set of subsections may be based on a comparison between the query vector and individual selected subsection summary vectors summarizing semantic meanings of individual subsections included in individual ones of the set of sections. The individual selected subsection summary vectors may be included in the individual sets of subsection summary vectors.

In some implementations, operation 220 may include using at least one of the one or more machine learning models. By way of non-limiting example, the at least one of the one or more machine learning models may be configured to compare vectors characterizing semantic meaning of individual sequences of text. Operation 220 may be performed by one or more hardware processors configured by machine-readable instructions including a component that is the same as or similar to summary traversal component 122 (shown in FIG. 1), in accordance with one or more implementations.

An operation 222 may include providing a prompt to at least one of the one or more machine learning models using individual semantic vectors. In some implementations, the individual semantic vectors may characterize individual semantic meanings of individual subsections included in the determined set of subsections as context. In some implementations, the prompt may be based on the query. In some implementations, the at least one of the one or more machine learning models may be configured to take as input a vector characterizing semantic meaning of a prompt. The at least one of the one or more machine learning models may be configured to generate a vector characterizing semantic meaning of a response to the prompt based on one or more vectors characterizing semantic meaning of sequences of text provided as context. Operation 222 may be performed by one or more hardware processors configured by machine-readable instructions including a component that is the same as or similar to information extraction component 124 (shown in FIG. 1), in accordance with one or more implementations.

An operation 224 may include obtaining one or more replies from the at least one or more machine learning models in reply to the prompt. Operation 224 may be performed by one or more hardware processors configured by machine-readable instructions including a component that is the same as or similar to information extraction component 124 (shown in FIG. 1), in accordance with one or more implementations.

An operation 226 may include presenting to the user the one or more replies. Operation 226 may be performed by one or more hardware processors configured by machine-readable instructions including a component that is the same as or similar to information extraction component 124 (shown in FIG. 1), in accordance with one or more implementations.

An operation 228 may include generating individual natural language summarizations of individual semantic meanings of one or more of individual documents, individual sections, individual subsections, and/or other types of divisions. Operation 228 may include generating individual natural language summarizations of individual documents based on individual document summary vectors. By way of non-limiting example, a first natural language document summarization of semantic meaning of the first document may be generated based on the first document summary vector. Operation 228 may include generating individual natural language summarizations of individual sections based on individual section summary vectors. By way of non-limiting example, a first natural language section summarization of semantic meaning of the first section may be generated based on the first section summary vector. Operation 228 may include generating individual natural language summarizations of individual subsections based on individual subsection summary vectors. By way of non-limiting example, a first natural language subsection summarization of semantic meaning of the first subsection may be generated based on the first subsection summary vector.

In some implementations, the natural language summarizations may be generated using at least one of the one or more machine learning models. The at least one of the one or more machine learning models may be configured to take vectors characterizing semantic meaning of individual sequences of text as input and to create sequences of text based on the input vectors. Operation 228 may include providing vectors characterizing semantic meaning of individual sequences of text as input for the at least one of the one or more machine learning models. Operation 228 may be performed by one or more hardware processors configured by machine-readable instructions including a component that is the same as or similar to information natural language component 126 (shown in FIG. 1), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to use one or more machine learning models to summarize a set of one or more documents, the system comprising:
one or more hardware processors configured by machine-readable instructions to:
obtain one or more documents including a first document, wherein the first document includes one or more sections including a first section, wherein the first section includes one or more subsections including a first subsection, wherein individual ones of the one or more subsections are arranged in a particular order, wherein individual ones of the one or more subsections included in the first section are subsections within the first document, wherein the first subsection includes one or more sequences of text including a first sequence of text;
identify, using at least one of the one or more machine learning models, individual sets of sections corresponding to individual ones of the one or more documents such that a first set of sections from the first document is identified, wherein the first document includes individual sections included in the first set of sections, wherein the first set of sections includes the first section;
identify, using at least one of the one or more machine learning models, individual sets of subsections corresponding to individual sections included in the individual sets of sections such that a first set of subsections for the first section is identified, wherein the first set of subsections includes the first subsection;
create, using at least one of the one or more machine learning models, individual sets of semantic vectors such that a first set of semantic vectors including a first semantic vector is created, wherein individual semantic vectors characterize semantic meanings of individual subsections such that the first semantic vector characterizes semantic meaning of the first subsection;
generate, using at least one of the one or more machine learning models, individual sets of subsection summary vectors in accordance with the individual sets of semantic vectors such that a first set of subsection summary vectors including a first subsection summary vector is generated in accordance with the first set of semantic vectors, wherein individual subsection summary vectors summarize semantic meaning of individual subsections such that the first subsection summary vector summarizes semantic meaning of the first subsection;
generate, using at least one of the one or more machine learning models, individual sets of section summary vectors in accordance with the individual sets of subsection summary vectors such that a first section summary vector is generated in accordance with the first set of subsection summary vectors, wherein individual section summary vectors summarize semantic meaning of individual sections such that the first section summary vector summarizes semantic meaning of the first section; and
generate, using at least one of the one or more machine learning models, individual document summary vectors in accordance with the individual sets of section summary vectors such that a first document summary vector is generated in accordance with the first set of section summary vectors, wherein individual document summary vectors summarize semantic meaning of individual documents such that the first document summary vector summarizes semantic meaning of the first document.

2. The system of claim 1, wherein at least one of the one or more machine learning models is configured to:
receive token embeddings as input; and
based on the token embeddings as received, create vectors characterizing semantic meaning of individual sequences of text, wherein creating an individual semantic vector associated with an individual subsection includes:
dividing the individual sequence of text included in the individual subsection into individual tokens;
determining individual token embeddings for the individual tokens;
aggregating the individual token embeddings to generate an aggregated token embedding; and
generating, using at least one of the one or more machine learning models, the individual semantic vector based on the aggregated token embedding.

3. The system of claim 1, wherein at least one of the one or more machine learning models is configured to:
receive token embeddings as input and to generate vectors characterizing semantic meaning of individual sequences of text,
compare vectors characterizing semantic meaning of individual sequences of text,
take as input a vector characterizing semantic meaning of a prompt, and
generate a vector characterizing semantic meaning of a response to the prompt based on one or more vectors characterizing semantic meaning of sequences of text provided as context, wherein the one or more hardware processors are configured by machine-readable instructions to:
obtain a query from a user;
divide the query into individual tokens;
determine individual token embeddings for the individual tokens;
aggregate the individual token embeddings to generate an aggregated token embedding;
generate, using the aggregated token embedding as input for at least one of the one or more machine learning models, a query vector, wherein the query vector is a semantic vector characterizing semantic meaning of the query;
determine, using at least one of the one or more machine learning models, a subset of the one or more documents, wherein determining the subset of the one or more documents is based on a comparison between the query vector and the individual document summary vectors included in the set of document summary vectors;
determine, using at least one of the one or more machine learning models, a set of sections, wherein the sections included in the set of sections are included in the documents included in the subset of the one or more documents, wherein determining the set of sections is based on a comparison between the query vector and individual selected section summary vectors summarizing semantic meanings of individual sections included in individual ones of the subset of the one or more documents, wherein the individual selected section summary vectors are included in the individual sets of section summary vectors;
determine, using at least one of the one or more machine learning models, a set of subsections, wherein the subsections included in the set of sections are included in the sections included in the set of sections, wherein determining the set of subsections is based on a comparison between the query vector and individual selected subsection summary vectors summarizing semantic meanings of individual subsections included in individual ones of the set of sections, wherein the individual selected subsection summary vectors are included in the individual sets of subsection summary vectors;
provide a prompt to the at least one of the one or more machine learning models using individual semantic vectors characterizing individual semantic meanings of individual subsections included in the determined set of subsections as context, wherein the prompt is based on the query;
obtain one or more replies from the at least one of the one or more machine learning models in reply to the prompt; and
present to the user the one or more replies.

4. The system of claim 3, wherein individual semantic vectors characterizing semantic meanings of individual subsections adjacent to individual subsections included in the determined set of subsections within individual documents included in the subset of the one or more documents are provided as context to at least one of the one or more machine learning models.

5. The system of claim 1, wherein individual semantic vectors included in individual ones of the sets of semantic vectors are stored in a vector database.

6. The system of claim 1, wherein at least one of the one or more machine learning models is configured to take as input vectors characterizing semantic meaning of individual sequences of text and to create sequences of text based on the input vectors, wherein the one or more hardware processors are configured by machine-readable instructions to:
generate, using at least one of the one or more machine learning models, individual natural language summarizations of individual semantic meanings of one or more of
(i) individual documents based on individual document summary vectors such that a first natural language document summarization of semantic meaning of the first document is generated based on the first document summary vector,
(ii) individual sections based on individual section summary vectors such that a first natural language section summarization of semantic meaning of the first section is generated based on the first section summary vector, and
(iii) individual subsections based on individual subsection summary vectors such that a first natural language subsection summarization of semantic meaning of the first subsection is generated based on the first subsection summary vector.

7. The system of claim 1, wherein the one or more machine learning models are configured for one or more of computer vision and/or natural language processing, wherein the one or more machine learning models include one or more of
(i) a machine learning model configured to identify individual divisions of individual documents,
(ii) a machine learning model configured to receive token embeddings as input and to output vectors characterizing semantic meaning of individual sequences of text, and
(iii) a machine learning model configured to summarize sequences of text and/or summarizations of sequences of text.

8. The system of claim 1, wherein identifying an individual set of subsections includes identifying one or more individual paragraphs, individual charts, and/or individual graphics included in an individual section.

9. The system of claim 1, wherein an individual document is organized into an individual hierarchy, wherein an individual level of the individual hierarchy identifies one or more continuous divisions included in the individual document maintaining a common subject matter, wherein generality of common subject matter for individual continuous divisions varies at individual levels of the individual hierarchy, wherein individual summary vectors are generated for individual continuous divisions included in the individual document at the individual levels of the hierarchy.

10. The system of claim 1, wherein individual subsections included in individual sections are adjacent within the individual document such that the individual subsections included in the first step of subsections are adjacent within the first document.

11. A method for using one or more machine learning models to summarize a set of one or more documents, the method comprising:
obtaining one or more documents including a first document, wherein the first document includes one or more sections including a first section, wherein the first section includes one or more subsections including a first subsection, wherein individual ones of the one or more subsections are arranged in a particular order, wherein individual ones of the one or more subsections included in the first section are subsections within the first document, wherein the first subsection includes one or more sequences of text including a first sequence of text;
identifying, using at least one of the one or more machine learning models, individual sets of sections corresponding to individual ones of the one or more documents such that a first set of sections from the first document is identified, wherein the first document includes individual sections included in the first set of sections, wherein the first set of sections includes the first section;
identifying, using at least one of the one or more machine learning models, individual sets of subsections corresponding to individual sections included in the individual sets of sections such that a first set of subsections for the first section is identified, wherein the first set of subsections includes the first subsection;
creating, using at least one of the one or more machine learning models, individual sets of semantic vectors such that a first set of semantic vectors including a first semantic vector is created, wherein individual semantic vectors characterize semantic meanings of individual subsections such that the first semantic vector characterizes semantic meaning of the first subsection;
generating, using at least one of the one or more machine learning models, individual sets of subsection summary vectors in accordance with the individual sets of semantic vectors such that a first set of subsection summary vectors including a first subsection summary vector is generated in accordance with the first set of semantic vectors, wherein individual subsection summary vectors summarize semantic meaning of individual subsections such that the first subsection summary vector summarizes semantic meaning of the first subsection;
generating, using at least one of the one or more machine learning models, individual sets of section summary vectors in accordance with the individual sets of subsection summary vectors such that a first section summary vector is generated in accordance with the first set of subsection summary vectors, wherein individual section summary vectors summarize semantic meaning of individual sections such that the first section summary vector summarizes semantic meaning of the first section; and
generating, using at least one of the one or more machine learning models, individual document summary vectors in accordance with the individual sets of section summary vectors such that a first document summary vector is generated in accordance with the first set of section summary vectors, wherein individual document summary vectors summarize semantic meaning of individual documents such that the first document summary vector summarizes semantic meaning of the first document.

12. The method of claim 11, wherein at least one of the one or more machine learning models is configured to:
receive token embeddings as input; and
based on the token embeddings as received, create vectors characterizing semantic meaning of individual sequences of text, wherein creating an individual semantic vector associated with an individual subsection includes:
dividing the individual sequence of text included in the individual subsection into individual tokens;
determining individual token embeddings for the individual tokens;
aggregating the individual token embeddings to generate an aggregated token embedding; and
generating, using at least one of the one or more machine learning models, the individual semantic vector based on the aggregated token embedding.

13. The method of claim 11, wherein at least one of the one or more machine learning models is configured to:
receive token embeddings as input and to generate vectors characterizing semantic meaning of individual sequences of text,
compare vectors characterizing semantic meaning of individual sequences of text,
take as input a vector characterizing semantic meaning of a prompt, and generate a vector characterizing semantic meaning of a response to the prompt based on one or more vectors characterizing semantic meaning of sequences of text provided as context, wherein the method further comprises:
obtaining a query from a user;
dividing the query into individual tokens;
determining individual token embeddings for the individual tokens;
aggregating the individual token embeddings to generate an aggregated token embedding;
generating, using the aggregated token embedding as input for at least one of the one or more machine learning models, a query vector, wherein the query vector is a semantic vector characterizing semantic meaning of the query;
determining, using at least one of the one or more machine learning models, a subset of the one or more documents, wherein determining the subset of the one or more documents is based on a comparison between the query vector and the individual document summary vectors included in the set of document summary vectors;
determining, using at least one of the one or more machine learning models, a set of sections, wherein the sections included in the set of sections are included in the documents included in the subset of the one or more documents, wherein determining the set of sections is based on a comparison between the query vector and individual selected section summary vectors summarizing semantic meanings of individual sections included in individual ones of the subset of the one or more documents, wherein the individual selected section summary vectors are included in the individual sets of section summary vectors;
determining, using at least one of the one or more machine learning models, a set of subsections, wherein the subsections included in the set of sections are included in the sections included in the set of sections, wherein determining the set of subsections is based on a comparison between the query vector and individual selected subsection summary vectors summarizing semantic meanings of individual subsections included in individual ones of the set of sections, wherein the individual selected subsection summary vectors are included in the individual sets of subsection summary vectors;
providing a prompt to the at least one of the one or more machine learning models using individual semantic vectors characterizing individual semantic meanings of individual subsections included in the determined set of subsections as context, wherein the prompt is based on the query;
obtaining one or more replies from the at least one of the one or more machine learning models in reply to the prompt; and
presenting to the user the one or more replies.

14. The method of claim 13, wherein individual semantic vectors characterizing semantic meanings of individual subsections adjacent to individual subsections included in the determined set of subsections within individual documents included in the subset of the one or more documents are provided as context to at least one of the one or more machine learning models.

15. The method of claim 11, wherein individual semantic vectors included in individual ones of the sets of semantic vectors are stored in a vector database.

16. The method of claim 11, wherein at least one of the one or more machine learning models is configured to take as input vectors characterizing semantic meaning of individual sequences of text and to create sequences of text based on the input vectors, wherein the method further comprises:
generating, using at least one of the one or more machine learning models, individual natural language summarizations of individual semantic meanings of one or more of
(i) individual documents based on individual document summary vectors such that a first natural language document summarization of semantic meaning of the first document is generated based on the first document summary vector,
(ii) individual sections based on individual section summary vectors such that a first natural language section summarization of semantic meaning of the first section is generated based on the first section summary vector, and
(iii) individual subsections based on individual subsection summary vectors such that a first natural language subsection summarization of semantic meaning of the first subsection is generated based on the first subsection summary vector.

17. The method of claim 11, wherein the one or more machine learning models are configured for one or more of computer vision and/or natural language processing, wherein the one or more machine learning models include one or more of
(i) a machine learning model configured to identify individual divisions of individual documents,
(ii) a machine learning model configured to receive token embeddings as input and to output vectors characterizing semantic meaning of individual sequences of text, and
(iii) a machine learning model configured to summarize sequences of text and/or summarizations of sequences of text.

18. The method of claim 11, wherein identifying an individual set of subsections includes identifying one or more individual paragraphs, individual charts, and/or individual graphics included in an individual section.

19. The method of claim 11, wherein an individual document is organized into an individual hierarchy, wherein an individual level of the individual hierarchy identifies one or more continuous divisions included in the individual document maintaining a common subject matter, wherein generality of common subject matter for individual continuous divisions varies at individual levels of the individual hierarchy, wherein individual summary vectors are generated for individual continuous divisions included in the individual document at the individual levels of the hierarchy.

20. The method of claim 11, wherein individual subsections included in individual sections are adjacent within the individual document such that the individual subsections included in the first step of subsections are adjacent within the first document.
